(19) United States
(12) Patent Application Publication
(10) Pub. No.: US 2023/0042499 A1
(43) Pub. Date: Feb. 9, 2023

(54) ROMAN SHADE

(71) Applicant: Yung-Ching LAI, Chia Yi County (TW)

(72) Inventor: Yung-Ching LAI, Chia Yi County (TW)

(21) Appl. No.: 17/702,393

(22) Filed: Mar. 23, 2022

Related U.S. Application Data
(63) Continuation-in-part of application No. 17/396,024, filed on Aug. 6, 2021.

(51) Int. Cl. E06B 9/266

(52) U.S. Cl. CPC E06B 9/266; E06B 2009/2622

(57) ABSTRACT

A roman shade has a frame, a blind detachably mounted on the frame, a retraction device mounted on the frame, a rolling member, and two guiding members. The rolling member is retractably mounted on the retraction device and has a rolling tape. A bottom end of the rolling tape is free without being connected to the blind. The guiding members are mounted on the retraction device and are located beside two sides of the rolling member. Each guiding member has a guiding tape retractably mounted on the retraction device. A bottom end of the guiding tape surrounds a connecting rod, which is mounted on a body of the blind. The guiding tape is detachably connected to the body of the blind through the connecting rod. It is convenient to detach the body of the blind for cleaning the blind.

### BACKGROUND OF THE INVENTION

### 1. Field of the Invention

The present invention relates to a roman shade, and more particularly to a roman shade that is easy to be detached for cleaning.

### 2. Description of Related Art

With reference to FIG. 12, a conventional roman shade has a frame 90, a blind 91, a retraction device 92, a rolling shade 93, a tape 94, and a handle 95. The frame 90 is mounted on a ceiling. The blind 91 is mounted on a front surface of the frame 90. The retraction device 92 is mounted between two wings 96 of the frame 90. A top end of the rolling shade 93 is fixed on the retraction device 92. A bottom end of the rolling shade 93 is sewed on an inner surface of the blind 91. The tape 94 is fixedly mounted on the rolling shade 93 adjacent to the blind 91. The handle 95 is mounted on a bottom end of the tape 94.

In a folding operation, the rolling shade 93 is driven by and wound on the retraction device 92. The bottom end of the rolling shade 93 moves upwardly and drives the blind 91 to move upwardly.

In an unfolding operation, the handle 95 can be pulled downwardly by a user for driving the bottom end of the rolling shade 93 to move downwardly through the tape 94. The bottom end of the rolling shade 93 is sewed on the inner surface of the blind 91 and moves downwardly, so that the blind 91 is expanded through the rolling shade 93.

The bottom end of the rolling shade 93 is sewed and fixed on the inner surface of the blind 91. It is inconvenient to detach the blind 91 from the rolling shade 93 for cleaning.

Furthermore, another conventional roman shade replaces the said rolling shade 93 with two rolling tapes. Top ends of the two rolling tapes are fixed on the retraction device. Bottom ends of the two rolling tapes are sewed on an inner surface of the blind. Therefore, it is inconvenient to detach the blind from the two rolling tapes for cleaning.

To overcome the shortcomings, the present invention provides a roman shade to mitigate or obviate the aforementioned problems.

### SUMMARY OF THE INVENTION

The objective of the invention is to provide a roman shade that can solve the shortcoming that detaching the blind of the conventional roman shade is inconvenient for cleaning.

The roman shade has a frame, a blind, a retraction device, a rolling member, and multiple guiding members. The frame has two wings mounted at a spaced interval. The blind is detachably mounted on the frame and has a body and a connecting rod. The body is detachably mounted on the frame. The connecting rod is detachably mounted on an inner surface of the body. The retraction device is mounted between the two wings of the frame. The rolling member is mounted on the retraction device and has a rolling tape and a handle. The rolling tape is retractably mounted on the retraction device and is adjacent to an inner surface of the blind. The handle is mounted on a bottom end of the rolling tape. A top end of the rolling tape is fixed on the retraction device, and the bottom end of the rolling tape is free without being connected to the blind. The multiple guiding members are mounted on the retraction device at spaced intervals and are located beside two sides of the rolling member. Each one of the guiding members has a guiding tape. The guiding tape is retractably mounted on the retraction device and is adjacent to the inner surface of the blind. A bottom end of the guiding tape surrounds the connecting rod.

In the present invention, the retraction device is connected to the body of the blind only via the guiding tapes of the guiding members, and the guiding tapes are connected to the body of the blind by surrounding the connecting rod of the blind. Therefore, in a folding operation, the rolling tape driven by the retraction device is wound on the retraction device. The two guiding tapes of the guiding members are driven by the retraction device, are wound on the retraction device, and pull the body of the blind upward by the connecting rod. In an unfolding operation, the handle can be pulled downwardly by a user, and the rolling tape extends downwardly for driving the guiding tapes to extend downwardly through the retraction device. The guiding members simultaneously drive the body of the blind to extend downwardly.

In a cleaning operation, the connecting rod is detached from the body of the blind, and is detached from the guiding tapes as well. At this time, the guiding tapes are detached from the body of the blind. Therefore, it is convenient to detach the body of the blind for cleaning or changing the body of the blind.

In addition, since the guiding tape is connected to the body of the blind by surrounding the connecting rod, even though the manufacturer uses guiding tapes of different widths in roman shades of different types or models, the manufacturer does not need to manufacture connecters of different sizes to meet the guiding tapes of different widths. The guiding tapes of different widths can all surround the connecting rod, thereby simplifying the connecting structure and lowering the burden of the manufacturer.

Other objectives, advantages and novel features of the invention will become more apparent from the following detailed description when taken in conjunction with the accompanying drawings.

### BRIEF DESCRIPTION OF THE DRAWINGS

FIG. 1 is a front side view of a first embodiment of a roman shade in accordance with the present invention;

FIG. 2 is a rear side view of the roman shade in FIG. 1;

FIG. 3 is an enlarged rear side view of the roman shade in FIG. 1;

FIG. 4 is an exploded perspective view of a connecting rod of the roman shade in FIG. 1;

FIG. 5 is a cross sectional side view of the roman shade along line 5-5 in FIG. 3;

FIG. 6 is a cross sectional side view of the roman shade along line 6-6 in FIG. 3;

FIG. 7 is a perspective view of a rod connector in another embodiment of the roman shade in FIG. 1;

FIG. 8 is a rear side view of a second embodiment of a roman shade in accordance with the present invention;

FIG. 9 is a perspective view of a fixing tape and a fixing sleeve of the roman shade in FIG. 8;

FIG. 10 is a perspective view of a rod fixer in another embodiment of the roman shade in FIG. 8;

FIG. 11 is a perspective view of the rod fixer in still another embodiment of the roman shade in FIG. 1; and

FIG. 12 is a rear side view of a conventional roman shade in accordance with the prior art.

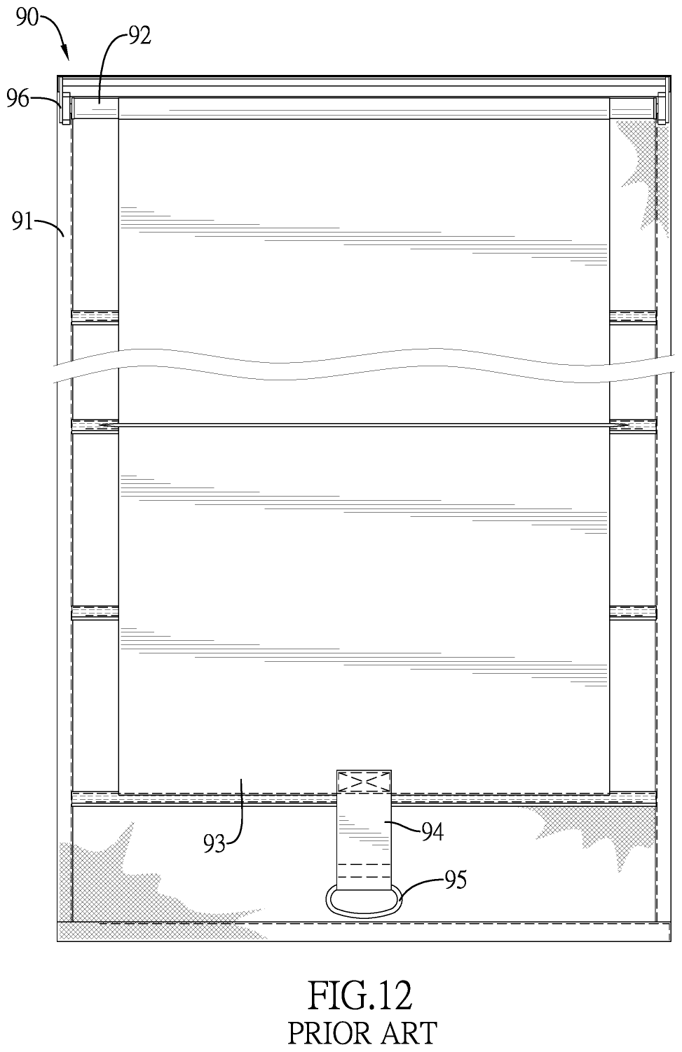

### DETAILED DESCRIPTION OF THE PREFERRED EMBODIMENT

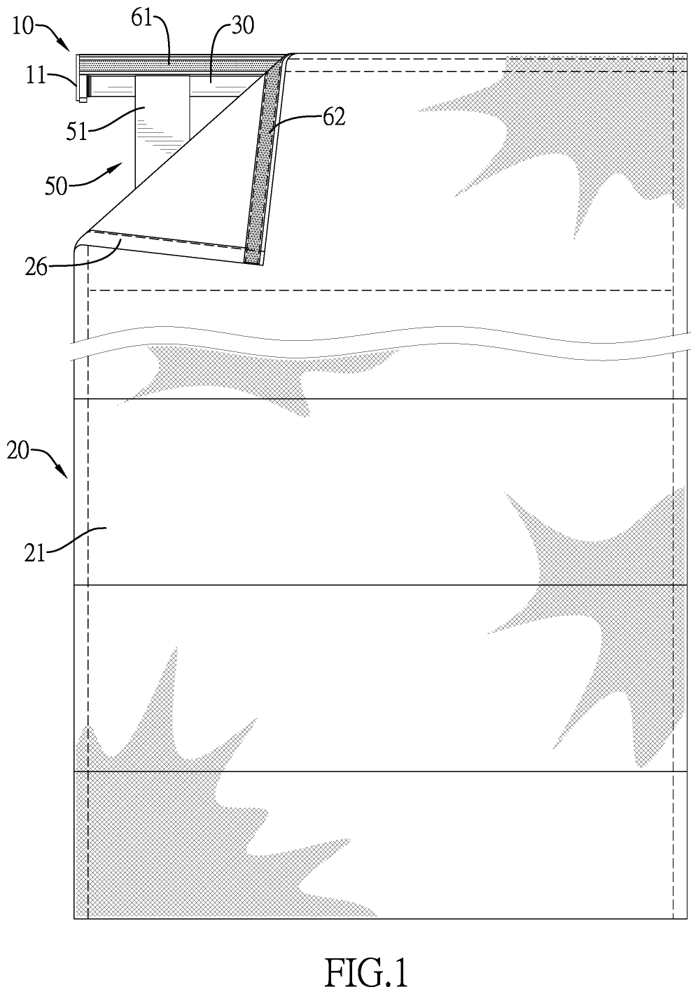

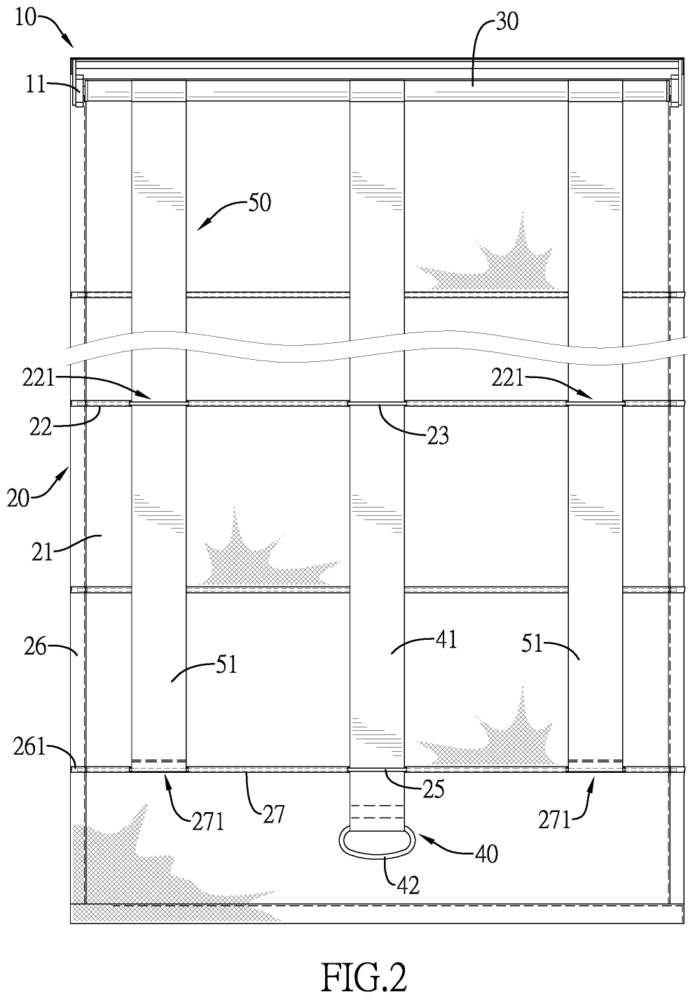

With reference to FIGS. 1 and 2, a first embodiment of a roman shade in accordance with the present invention has a frame 10, a blind 20, a retraction device 30, a rolling member 40, and multiple guiding members 50.

The frame 10 is mounted on a ceiling or a wall. The frame 10 has two wings 11 mounted at a spaced interval.

With reference to FIGS. 1 to 4, the blind 20 is detachably mounted on a front surface of the frame 10 and is used to shelter. The blind 20 has a body 21 and a connecting rod 25. The body 21 is detachably mounted on the frame 10. The connecting rod 25 is detachably mounted on an inner surface of the body 21. Preferably, the connecting rod 25 is adjacent to a bottom end of the body 21.

The retraction device 30 is mounted between the two wings 11 of the frame 10.

The rolling member 40 is mounted on the retraction device 30 and has a rolling tape 41 and a handle 42. The rolling tape 41 is retractably mounted on the retraction device 30 and is adjacent to an inner surface of the blind 20. The handle 42 is mounted on a bottom end of the rolling tape 41. A top end of the rolling tape 41 is fixed on the retraction device 30. The bottom end of the rolling tape 41 is free without being connected to the blind 20.

The guiding members 50 are mounted on the retraction device 30 at a spaced interval and are located beside two sides of the rolling member 40. Each one of the guiding members 50 has a guiding tape 51. The guiding tape 51 is retractably mounted on the retraction device 30 and is adjacent to the inner surface of the blind 20. A bottom end of the guiding tape 51 surrounds the connecting rod 25, such that the guiding tape 51 can move upward the body 21 of the blind 20 via the connecting rod 25.

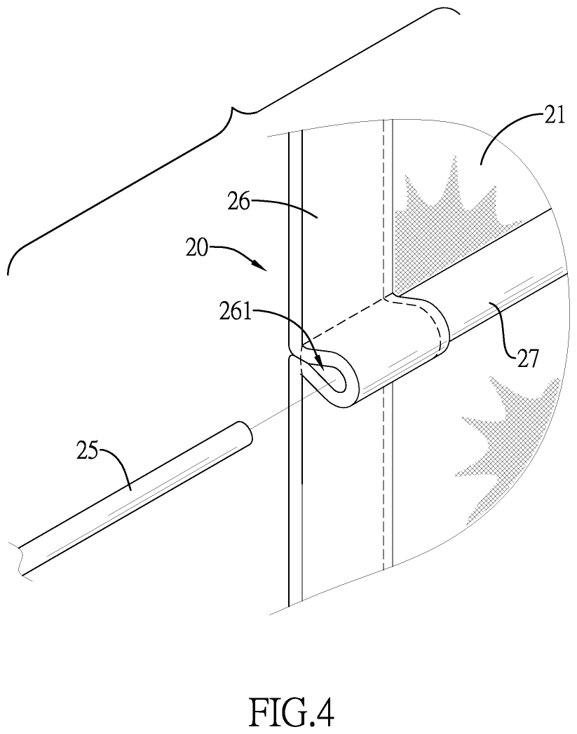

With reference to FIGS. 2, 3, and 6, regarding how the connecting rod 25 is detachably mounted on the body 21, in a preferred embodiment, the blind 20 further has two side tapes 26. The two side tapes 26 are mounted on the body 21 and are respectively disposed on two transverse sides of the body 21. Each of the side tapes 26 forms a side sleeve 261, and thus there are two side sleeves 261 in total by the two side tapes 26. Two ends of the connecting rod 25 are respectively inserted into the two side sleeves 261 of the two side tapes 26. Preferably, the side tape 26 is folded to form the side sleeve 261 as shown in FIG. 4. However, the side sleeve 261 may be formed between the side tape 26 and the body 21 of the blind 20.

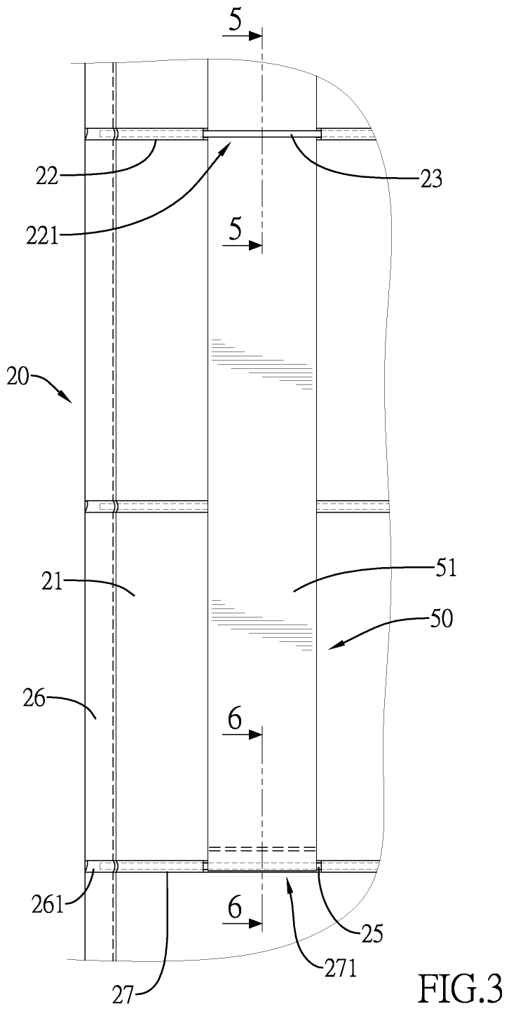

With reference to FIGS. 3 and 4, an inner end of the side sleeve 261 is an open end for inserting the connecting rod 25. An outer end of the side sleeve 261 may be a closed end such that the connecting rod 25 is detached from the body 21 from the inner end of the side sleeve 261. However, the outer end of the side sleeve 261 may be an open end such that the connecting rod 25 can be directly inserted into and detached from the outer end of the side sleeve 261 transversely as shown in FIG. 4.

With reference to FIGS. 2 and 3, in a preferred embodiment, the blind 20 has a middle sleeve 27. The middle sleeve 27 is integrally formed on the inner surface of the body 21, extends transversely, and has multiple notches 271 formed through the middle sleeve at spaced intervals. The connecting rod 25 is inserted in the middle sleeve 27. The bottom end of the guiding tape 51 of each guiding member 50 is connected to the connecting rod 25 via one of the notches 271 of the middle sleeve 27.

In a preferred embodiment as shown in FIG. 3, the connecting rod 25 is inserted in the middle sleeve 27 and the side sleeves 261 simultaneously, such that the connecting rod 25 is detachably mounted on the body 21. However, the side tapes 26 and the side sleeves 261 can be omitted, and the connecting rod 25 is detachably mounted on the body 21 only via the middle sleeve 27. Or, the middle sleeve 27 can be omitted, and the connecting rod 25 is detachably mounted on the body 21 only via the side tapes 26 and the side sleeves 261. Besides, the connecting rod 25 may be detachably mounted on the body 21 by other ways.

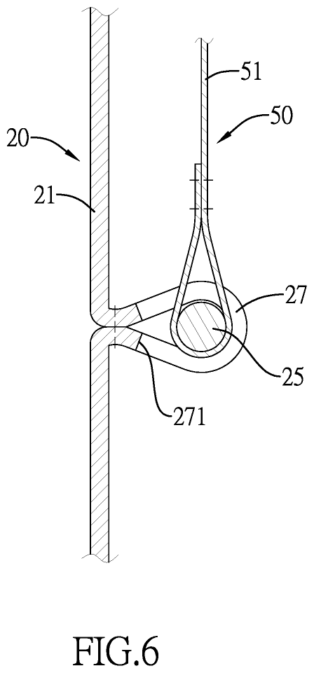

Regarding how the bottom end of the guiding tape 51 surrounds the connecting rod 25, in a preferred embodiment as shown in FIGS. 3 and 6, the bottom end of the guiding tape 51 surrounds the connecting rod 25 and then is sewed on the guiding tape 51 itself.

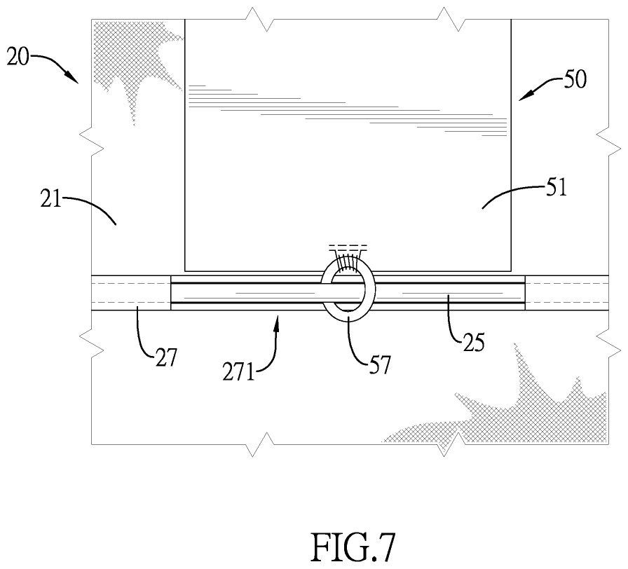

In another preferred embodiment as shown in FIG. 7, each one of the guiding members 50 has a rod connector 57. The rod connector 57 is mounted on the bottom end of the guiding tape 51 and surrounds the connecting rod 25. Preferably, the rod connector 57 is ring-shaped and is sewed on the guiding tape 51.

In another preferred embodiment, the bottom end of the guiding tape 51 forms a connecting hole for inserting the rod connector 57. At this time, the rod connector 57 may be a snap hook or a self-locking hook.

In another preferred embodiment, the bottom end of the guiding tape 51 forms a connecting hole to surround the connecting rod 25. Preferably, each one of the guiding members 50 has a reinforcing ring mounted on the connecting hole to surround the connecting rod 25.

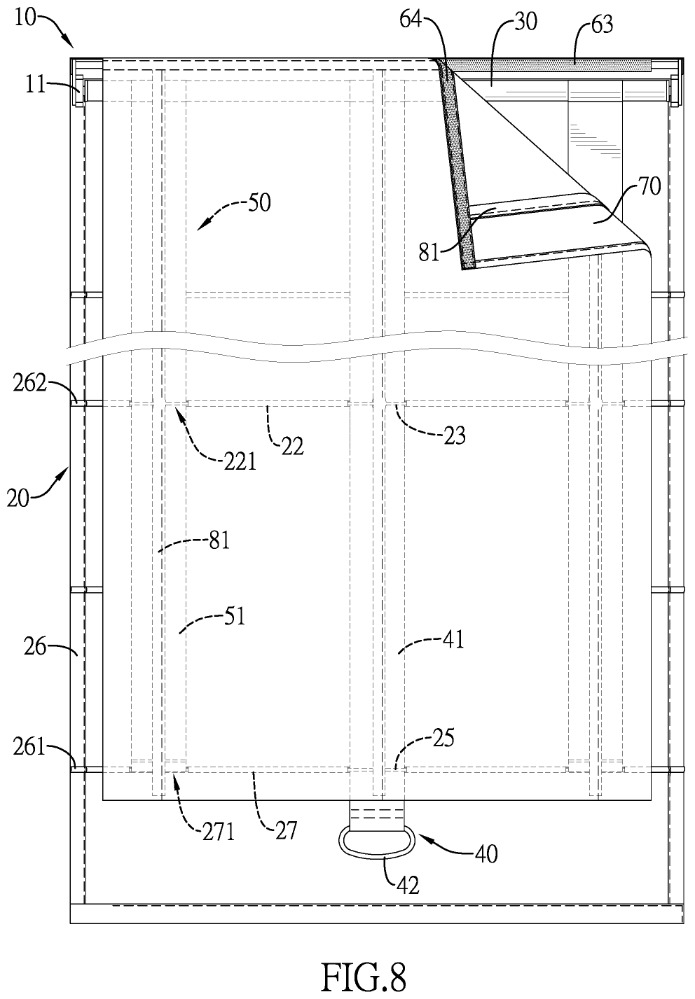

With reference to FIG. 8, a second embodiment of the roman shade is similar to the first embodiment, and the difference is that the second embodiment further comprises a shading cloth 70.

The rolling member 40 and the guiding members 50 are disposed between the blind 20 and the shading cloth 70, such that the rolling member 40 and the guiding members 50 are hidden. A top end of the shading cloth 70 is detachably mounted on the frame 10. A bottom end of the shading cloth 70 extends downward beyond the bottom end of the guiding tape 51. As a result, the rolling member 40 and most part of the guiding members 50 are hidden by the shading cloth 70 to enhance the aesthetic appeal.

Preferably, the shading cloth 70 is connected to the blind 20, such that the shading cloth 70 is folded upward when the blind 20 is folded upward. Preferably, the shading cloth 70 is connected to the blind 20 via a middle part of the blind 20, but the shading cloth 70 may be connected to the blind 20 via a bottom end of the blind 20.

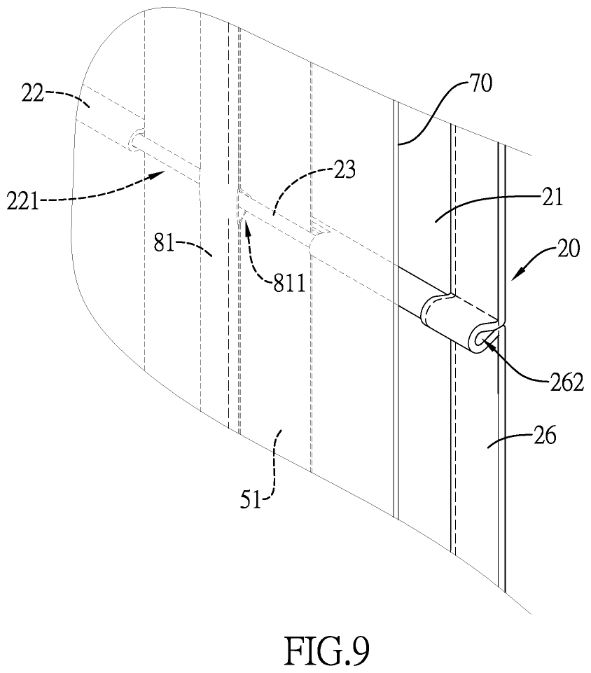

With reference to FIGS. 8 and 9, regarding how the shading cloth 70 is connected to the blind 20, in a preferred embodiment, the blind has a transverse rod 23 connected to the body 21 of the blind 20. The shading cloth 70 is connected to the transverse rod 23.

Regarding how the transverse rod 23 is connected to the body 21 of the blind 20, in a preferred embodiment, the blind 20 has a sleeve portion 22. The sleeve portion 22 is integrally formed on the inner surface of the body 21, extends transversely and has multiple notches 221 formed through the sleeve portion 22 at spaced intervals. The transverse rod 23 is inserted through the sleeve portion 22. The shading cloth 70 is connected to the transverse rod 23 via the notches 221 of the sleeve portion 22.

Further, the two side tapes 26 may form another two side sleeves 262, and two ends of the transverse rod 23 may be respectively inserted into the two side sleeves 262 of the two side tapes 26. However, the side tapes 26 and the side sleeves 262 can be omitted, and the transverse rod 23 is mounted on the body 21 only via the sleeve portion 22. Or, the sleeve portion 22 can be omitted, and the transverse rod 23 is mounted on the body 21 only via the side tapes 26 and the side sleeves 262. Besides, the transverse rod 23 may be detachably mounted on the body 21 by other ways.

Regarding how the shading cloth 70 is connected to the transverse rod 23, in a preferred embodiment as shown in FIGS. 8 and 9, there are multiple fixing tapes 81 mounted on the shading cloth 70. Each one of the fixing tapes 81 and the shading cloth 70 form a fixing sleeve 811 to surround the transverse rod 23.

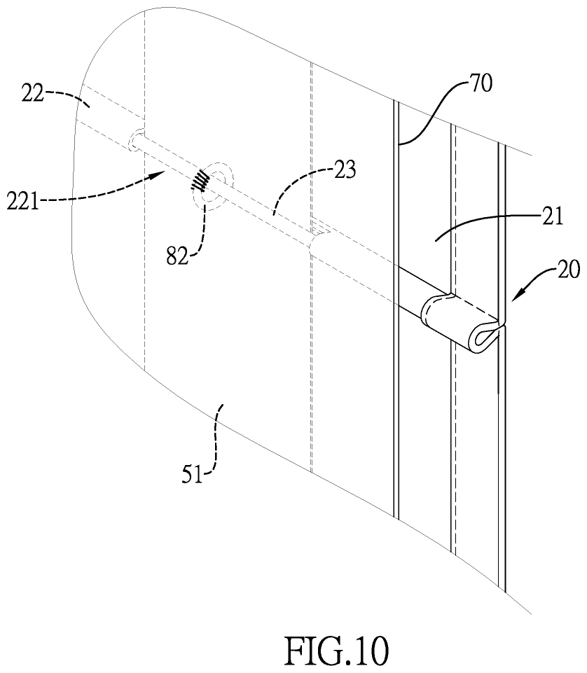

In another preferred embodiment as shown in FIG. 10, multiple rod fixers 82 are mounted on the shading cloth 70 and are connected to the transverse rod 23. Preferably, each one of the rod fixers 82 is ring-shaped, is sewed on the shading cloth 70, and surrounds the transverse rod 23.

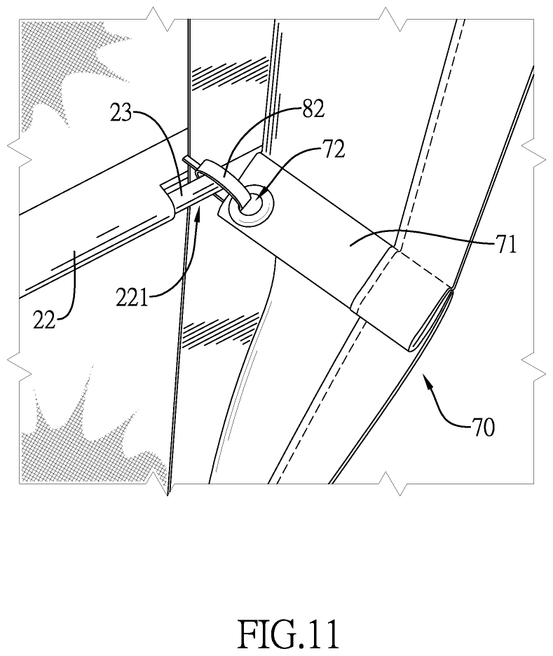

In another preferred embodiment as shown in FIG. 11, the shading cloth 70 forms a pleat 71 and forms multiple fixing holes 72 on the pleat 71. Each one of the rod fixers 82 is a snap hook and hooks one of the fixing holes 72 and the transverse rod 23.

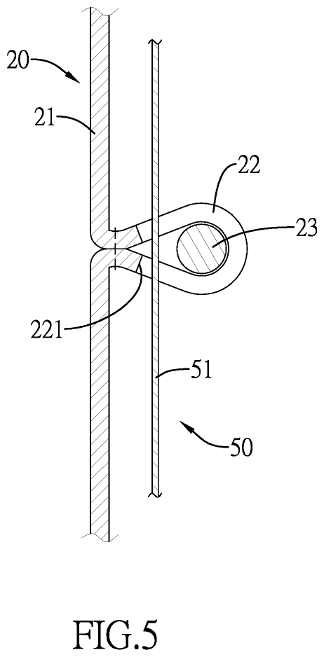

Preferably, the guiding tapes 51 of the guiding members 50 pass through the notches 221 of the sleeve portion 22, and are disposed between the transverse rod 23 and the body 21 of the blind 20 as shown in FIGS. 3 and 5.

With reference to FIG. 1, in the first embodiment, the roman shade has a first fastener 61 and a second fastener 62. The first fastener 61 is fixedly mounted on the front surface of the frame 10. The second fastener 62 is fixedly mounted on the inner surface of the blind 20 and is detachably connected to the first fastener 61. The first fastener 61 and the second fastener 62 are preferably adhesive straps.

With reference to FIG. 8, in the second embodiment, the roman shade has a third fastener 63 and a fourth fastener 64. The third fastener 63 is fixedly mounted on a rear surface of the frame 10. The fourth fastener 64 is fixedly mounted on an inner surface of the shading cloth 70 and is detachably connected to the third fastener 63. The third fastener 63 and the fourth fastener 64 are preferably adhesive straps.

In a folding operation, the rolling tape 41 and the guiding tapes 51 are driven by the retraction device 30 and are wound on the retraction device 30 simultaneously. The guiding tapes 51 are connected to the body 21 of the blind 20 through the connecting rod 25 and can pull the body 21 of the blind 20 upward to fold the blind 20.

In an unfolding operation, the handle 42 can be pulled downwardly by a user. The rolling tape 41 extends downwardly for driving the guiding tapes 51 to extend downwardly through the retraction device 30. The guiding members 50 simultaneously drive the blind 20 to extend downwardly for sheltering.

In a cleaning operation, the second fastener 62 is detached from the first fastener 61, such that the blind 20 is detached from the frame 10. Then, the connecting rod 25 is detached from the body 21 of the blind 20 from the side sleeve 261 and the middle sleeve 27. The connecting rod 25 is also detached from the bottom ends of the guiding tapes 51. As a result, the body 21 of the blind 20 is detached from the frame 10 and the guiding members 50 for easily cleaning or changing.

Accordingly, the bottom end of the rolling tape 41 is free without being connected to the body 21 of the blind 20, and the guiding tapes 51 only surround the connecting rod 25, which can be detached from the body 21 of the blind 20 easily. Detaching the blind 20 is convenient.

In addition, since the guiding tape 51 is connected to the body 21 of the blind 20 by surrounding the connecting rod 25, even though the manufacturer uses guiding tapes 51 of different widths in roman shades of different types or models, the manufacturer does not need to manufacture connecters of different sizes to meet the guiding tapes 51 of different widths. The guiding tapes 51 of different widths can all surround the connecting rod 25, thereby simplifying the connecting structure, and lowering the burden of the manufacturer.

What is claimed is:

1. A roman shade comprising:
a frame having two wings mounted at a spaced interval;
a blind detachably mounted on the frame and having
a body detachably mounted on the frame;
a connecting rod detachably mounted on an inner surface of the body;
a retraction device mounted between the two wings of the frame;
a rolling member mounted on the retraction device and having
a rolling tape retractably mounted on the retraction device and adjacent to an inner surface of the blind;
a handle mounted on a bottom end of the rolling tape;
wherein a top end of the rolling tape is fixed on the retraction device, and the bottom end of the rolling tape is free without being connected to the blind; and
multiple guiding members mounted on the retraction device at spaced intervals and located beside two sides of the rolling member, and each one of the guiding members having
a guiding tape retractably mounted on the retraction device and adjacent to the inner surface of the blind; a bottom end of the guiding tape surrounding the connecting rod.

2. The roman shade as claimed in claim 1, wherein
the blind has
two side tapes mounted on the body and respectively disposed on two transverse sides of the body; each of the side tapes forming a side sleeve;
two ends of the connecting rod are respectively inserted into the two side sleeves of the two side tapes.

3. The roman shade as claimed in claim 1, wherein
the blind has
a middle sleeve integrally formed on the inner surface of the body, extending transversely, and having
multiple notches formed through the middle sleeve at spaced intervals; and
the connecting rod is inserted in the middle sleeve;
in each one of the guiding members, the bottom end of the guiding tape connected to the connecting rod via one of the notches of the middle sleeve.

4. The roman shade as claimed in claim 1, wherein the bottom end of the guiding tape surrounds the connecting rod and then is sewed on the guiding tape itself.

5. The roman shade as claimed in claim 1, wherein each one of the guiding members has
a rod connector mounted on the bottom end of the guiding tape and surrounding the connecting rod.

6. The roman shade as claimed in claim 5, wherein the rod connector is ring-shaped and is sewed on the guiding tape.

7. The roman shade as claimed in claim 1 further comprising:
a shading cloth; the rolling member and the guiding members disposed between the blind and the shading cloth; a top end of the shading cloth detachably mounted on the frame; a bottom end of the shading cloth extending downward beyond the bottom end of the guiding tape.

8. The roman shade as claimed in claim 7, wherein the shading cloth is connected to the blind, such that the shading cloth is folded upward when the blind is folded upward.

9. The roman shade as claimed in claim 8, wherein
the blind has
a transverse rod connected to the body of the blind;
the shading cloth is connected to the transverse rod.

10. The roman shade as claimed in claim 9, wherein
the blind has
a sleeve portion integrally formed on the inner surface of the body, extending transversely, and having
multiple notches formed through the sleeve portion at spaced intervals; and
the transverse rod is inserted through the sleeve portion;
the shading cloth is connected to the transverse rod via the notches of the sleeve portion.

11. The roman shade as claimed in claim 9, wherein
the blind has
two side tapes mounted on the inner surface of the body and respectively disposed on two transverse sides of the body; each of the side tapes forming a side sleeve;
two ends of the transverse rod are respectively inserted into the two side sleeves of the two side tapes.

12. The roman shade as claimed in claim 9 further comprising:
multiple fixing tapes mounted on the shading cloth; each one of the fixing tapes and the shading cloth forming a fixing sleeve to surround the transverse rod.

13. The roman shade as claimed in claim 9 further comprising:
multiple rod fixers mounted on the shading cloth and connected to the transverse rod.

14. The roman shade as claimed in claim 13, wherein each one of the rod fixers is ring-shaped, is sewed on the shading cloth, and surrounds the transverse rod.

15. The roman shade as claimed in claim 13, wherein the shading cloth forms multiple fixing holes, and each one of the rod fixers is a snap hook to hook one of the fixing holes and the transverse rod.

16. The roman shade as claimed in claim 1, wherein the roman shade has
a first fastener fixedly mounted on the frame; and
a second fastener fixedly mounted on the inner surface of the blind and detachably connected to the first fastener.
